(19) United States
(12) Patent Application Publication
(10) Pub. No.: US 2026/0174272 A1
(43) Pub. Date: Jun. 25, 2026

(54) BEVERAGE-MAKING MACHINE

(71) Applicant: Hamilton Beach Brands, Inc., Glen Allen, VA (US)

(72) Inventors: Koen Ambrose, Glen Allen, VA (US); Mark Olszowy, Glen Allen, VA (US)

(73) Assignee: Hamilton Beach Brands, Inc., Glen Allen, VA (US)

(21) Appl. No.: 18/990,718

(22) Filed: Dec. 20, 2024

(51) Int. Cl. A47J 31/44; A47J 31/46; A47J 31/54

(52) U.S. Cl. CPC A47J 31/446; A47J 31/461; A47J 31/465; A47J 31/468; A47J 31/545

(57) ABSTRACT

A beverage-making machine includes: a housing having a base with first and second vessel receiving areas, a tower extending upwardly from the base, and a dispensing arm that extends from the tower at least partially directly above the first and second vessel receiving areas; a water reservoir mounted in the housing; a first brew basket positioned in the dispensing arm and above the first vessel receiving area; a second brew basket positioned in the dispensing arm and above the second vessel receiving area; a heat generating unit fluidly connected with the water reservoir; a pump fluidly connected with the water reservoir; a three-way valve assembly fluidly connected with the heat generating unit, the first brew basket and the second brew basket, the three-way valve assembly configured to switch between a first position, in which fluid is permitted to flow to the first brew basket but not to the second brew basket, and a second position, in which fluid is permitted to flow to the second brew basket but not to the first brew basket; and a controller operatively connected with the heat generating unit, the pump and the three-way valve assembly. The controller is configured to switch the three-way valve assembly from the first position to the second position after a first predetermined time interval before completing brewing via the first brew basket.

### FIELD OF THE INVENTION

The present invention relates generally to small appliances, and more specifically to beverage makers.

### BACKGROUND

Automatic drip coffeemakers are well known and widely used. They are effective at brewing carafes of coffee, typically containing five to eight cups (a “coffee cup” is historically 5 ounces) or more of liquid. Automatic drip coffeemakers may also be used for brewing small batches, namely one to four coffee cups (5 to 20 ounces).

A typical automatic drip coffeemaker includes a brew basket that contains ground coffee (presented loosely in a bowl-shaped filter or within a “pod” type package often referred to “K-Cups®”). Heated water is conveyed to the brew basket and released, where it gravimetrically flows downwardly through the coffee grounds and into a receptacle such as a carafe or pot. Exemplary automatic drip coffeemakers are discussed in U.S. Pat. No. 5,001,969 to Moore et al.; 7,066,080 to Hsu; and 8,065,952 to Wang, the disclosures of which are hereby incorporated herein by reference in full. Some coffeemakers are designed to brew coffee in different forms; for example, coffeemakers offered in the FLEXBREW® line of products available from Hamilton Beach Brands (Richmond, Virginia; applicant in this matter) include an insert that enables the user to choose between a pod or loose ground coffee.

Moreover, another coffeemaker offered in the FLEXBREW® line of coffeemakers has two different “stations,” one of which can brew a full pot or carafe, and the other of which brews a single serving (often utilizing a pod as described above). This coffeemaker can provide the user with the flexibility of brewing either a single serving, if that is all that is desired, or multiple servings in a pot or carafe.

It may be desirable to provide performance improvements and flexibility to coffeemakers.

### SUMMARY

As a first aspect, embodiments of the invention are directed to a dual-vessel beverage-making machine. The beverage-making machine comprises: a housing comprising a base with first and second vessel receiving areas, a tower extending upwardly from the base, and a dispensing arm that extends from the tower at least partially directly above the first and second vessel receiving areas; a water reservoir mounted in the housing; a first brew basket positioned in the dispensing arm and above the first vessel receiving area; a second brew basket positioned in the dispensing arm and above the second vessel receiving area; a heat generating unit fluidly connected with the water reservoir; a pump fluidly connected with the water reservoir; a three-way valve assembly fluidly connected with the heat generating unit, the first brew basket and the second brew basket, the three-way valve assembly configured to switch between a first position, in which fluid is permitted to flow to the first brew basket but not to the second brew basket, and a second position, in which fluid is permitted to flow to the second brew basket but not to the first brew basket; and a controller operatively connected with the heat generating unit, the pump and the three-way valve assembly. The controller is configured to switch the three-way valve assembly from the first position to the second position after a first predetermined time interval before completing brewing via the first brew basket.

As a second aspect, embodiments of the invention are directed to a method of brewing a beverage. The method comprising the steps of:
(a) providing a beverage-making machine as discussed above;
(b) inserting first beverage grounds in the first brew basket;
(c) inserting second beverage grounds in the second brew basket;
(d) conveying water from the water reservoir to the first brew basket to brew a beverage with the first beverage grounds, wherein the three-way valve assembly is in the first position; then
(e) conveying water from the water reservoir to the second brew basket to brew a beverage with the second beverage grounds, wherein the three-way valve assembly is in the first position; and
(f) alternately repeating steps (d) and (e).

### BRIEF DESCRIPTION OF THE FIGURES

FIG. 1 is a schematic diagram of a beverage-making machine according to embodiments of the invention.

FIG. 2 is a front perspective view of the beverage-making machine of FIG. 1.

FIG. 3 is a rear perspective view of the beverage-making machine of FIG. 1.

FIG. 4 is a partial front perspective view of the beverage-making machine of FIG. 1 with the cover pivoted to permit the insertion of grounds into the brew baskets.

FIG. 5 is a partial front bottom perspective view of the beverage-making machine of FIG. 1 showing the exit nozzles of the brew backets.

FIG. 6 is a schematic view of components of the beverage-making machine of FIG. 1.

FIG. 7 is a perspective view of a brew basket of the beverage-making machine of FIG. 1 configured to receive a hard-shelled pod of grounds.

FIGS. 8A and 8B are assembled and exploded perspective views of a brew basket of the beverage-making machine of FIG. 1 configured to receive loose grounds.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

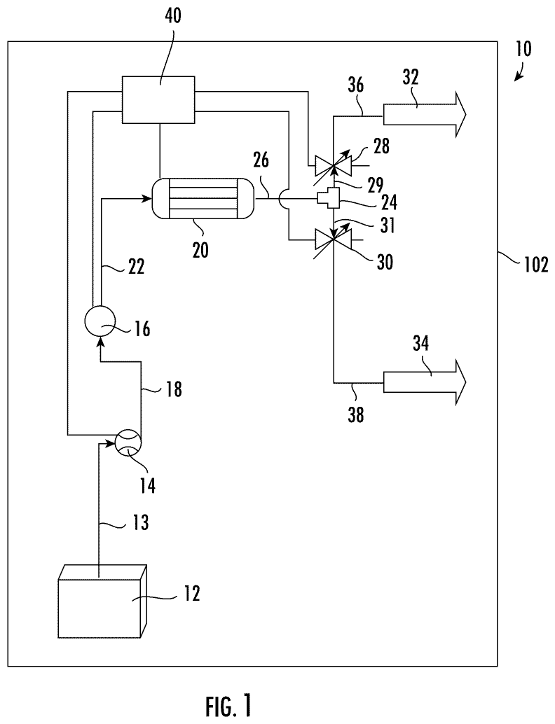

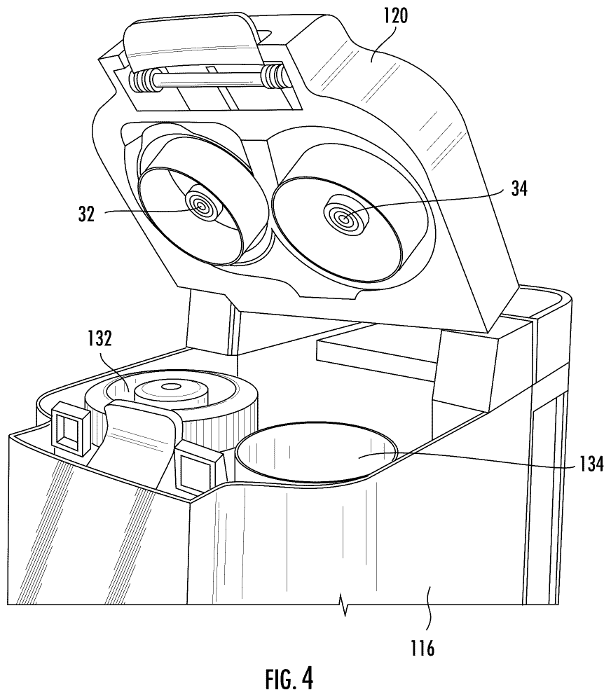

Referring now to FIG. 1, a schematic diagram of a coffeemaker, designated broadly at 10, is shown therein. The coffeemaker 10 includes a cold water reservoir 12, a flow meter 14 connected with the water reservoir 12 via a line 13, a cold water pump 16 that is fluidly connected with the flow meter 14 via a line 18, a hot water generator 20 (e.g., a heater) that is fluidly connected to the cold water pump 16 via a line 22, a T-fitting 24 that is fluidly connected with the hot water generator 20 via a line 26, two valves 28, 30 (e.g., in the form of solenoid valves) that are fluidly connected to the T-fitting 24 via lines 29, 31, and two dispensing needles 32, 34 that are connected with the valves 28, 30 via lines 36, 38 respectively. Each of the needles 32, 34 is positioned to supply heated water to a respective brew basket 132, 134 (not shown in FIG. 1, but seen in FIG. 4), each of which dispenses into a separate vessel. A controller 40 is operatively connected with the cold water pump 16, the flow meter 14, the hot water generator 20, and the valves 28, 30. Some or all of these components may be mounted on or within a housing (shown schematically at 102).

As can be discerned from FIG. 1, the coffeemaker 10 has the capability of dispensing coffee (or another brewed beverage) to either of two vessels essentially simultaneously. The water for brewing is supplied by the cold water reservoir 12, pumped by the cold water pump 16 (with the quantity monitored by the flow meter 14), heated by the hot water generator 20, and conveyed to and through the T-fitting 24 to the valves 28, 30. Much of this arrangement is relatively common in conventional coffeemakers. However, the controller 40 is configured to switch on one or the other of the valves 28, 30, which enables the hot water to flow to either the dispensing needle 32 or the dispensing needle 34. Moreover, the controller 40 is configured to switch which of the valves 28, 30 is open during dispensing, such that the heated water may be redirected from one of the dispensing needles 32, 34 to the other during dispensing. As one example, the controller 40 may switch between the valves 28, 30 every 3-7 seconds during dispensing, such that each dispensing needle 32, 34 receives hot water in a discontinuous but regular sequence. As a result, the coffeemaker 10 provides the user with the capability of dispensing brewed beverage into two different vessels during the same brewing operation.

This capability may be desirable for several reasons. First, the user can provide guests with two cups of hot beverage at the same time, rather than having to first serve one guest, then the other. Second, the user can also make two different types of beverage at the same time. For example, one brewing basket may be loaded with a dark roast coffee, while the other brewing basket is loaded with a light roast coffee. Under these conditions, both types of coffee can be brewed and served at the same time. Third, the user can provide two cups of beverage brewed from grounds that are provided in different forms. For example, one cup may be brewed from rounds within a pod (which typically requires relatively high pressure from the pump 20), while another cup may be brewed from loose grounds (which typically requires relatively low pressure). Because each of the valves 28, 30 is closed when the other of the valves 28, 30 is open, the correct pressure can be applied to the selected dispensing needle 32, 34 and brew basket 132, 134 without negatively impacting the other dispensing needle 34, 32 or brew basket 134, 132.

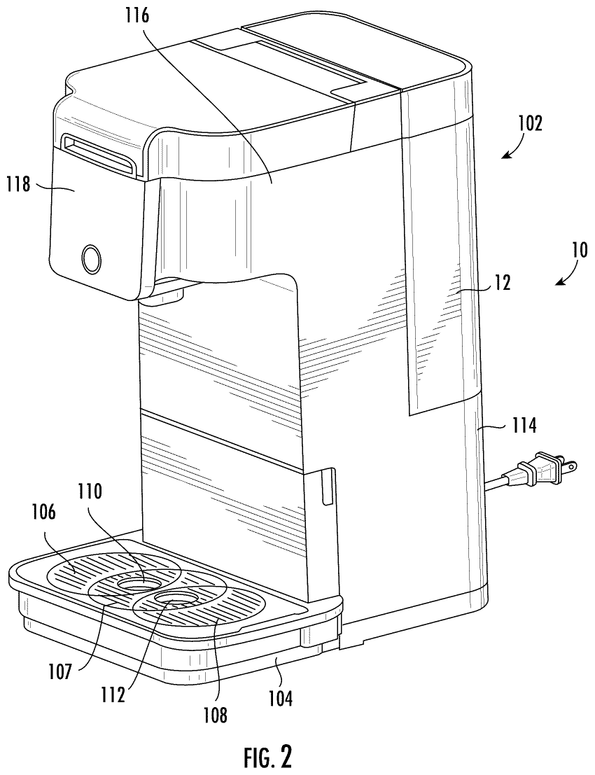

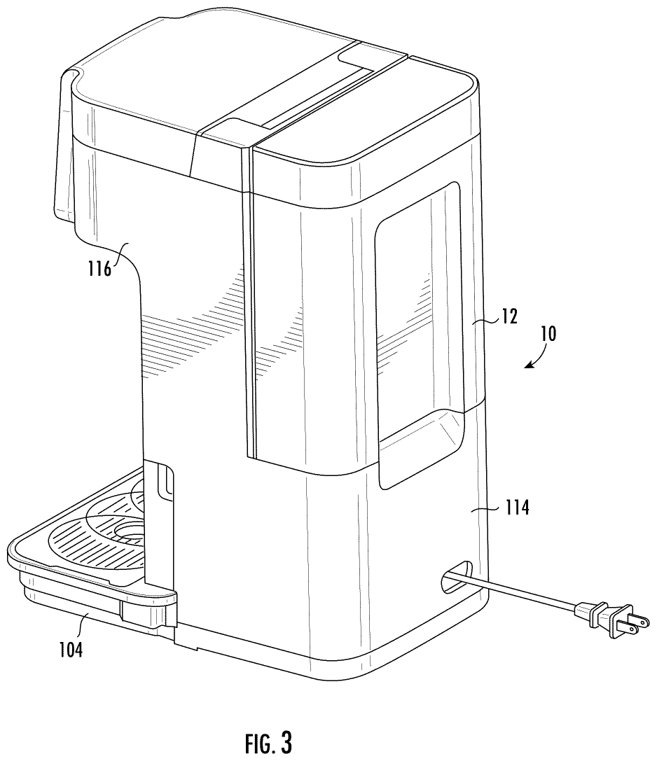

FIGS. 2-8B illustrate one embodiment of the coffeemaker 10. As seen in FIGS. 2 and 3, the coffeemaker 10 has an outer housing 102 that includes a base 104 with three vessel receiving areas 106, 107, 108. Two openings 110, 112 are also present in the base 104. The housing 102 also includes a vertical tower 114 that rises rearwardly from the base. A dispensing arm 116 is cantilevered forwardly from the tower 114 and overhangs the base 104. A control panel 118 is mounted on the front surface of the dispensing arm 116 and includes buttons, touch screens, or the like to enable the user to operate the coffeemaker 10 and to make specific operation selections. The control panel 118 is operatively connected with the controller 40.

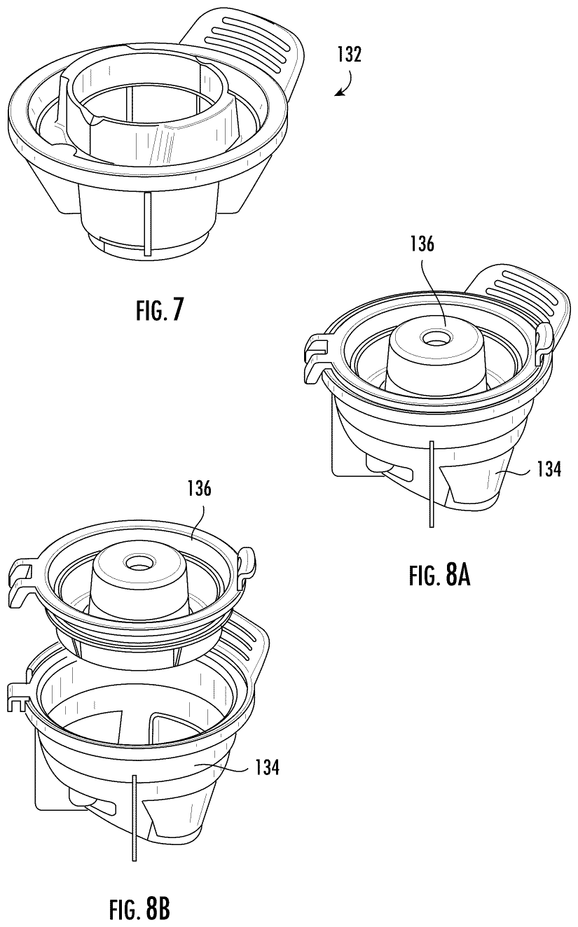

Referring now to FIG. 4, the dispensing arm 116 is shown therein with its cover 120 pivoted to a raised position. The dispensing needles 32, 34 are mounted on the underside of the cover 120. The dispensing needles 32, 34, can be lowered via pivoting of the cover 120 to feed brew baskets 132, 134, which are replaceably mounted in the fixed portion of the dispensing arm 116. Each brew basket 132, 134 may covered with a respective lid 136 (see FIGS. 8A and 8B); each lid 136 has an opening through which the needles 32, 34 extend. FIG. 5 illustrates nozzles 142, 144 mounted on the underside of the dispensing arm 116 that are positioned to route brewed beverage from the brew baskets 132, 134 to vessels positioned on the vessel receiving areas 106, 107, 108.

It should be noted that the nozzles 142, 144 are not centered over the vessel receiving areas 106, 108, but instead are eccentrically mounted, with each nozzle 142, 144 being located nearer to the center line of the base 104. These locations enable both of the nozzles 142, 144 to be positioned above the vessel receiving area 107. In turn, this enables a single vessel (e.g., a fairly wide-mouthed mug) positioned on the center vessel receiving area 107 to receive brewed beverage from both nozzles 142, 144. This may be done if a user wishes to mix two different beverages in the same vessel (e.g., coffee and hot chocolate).

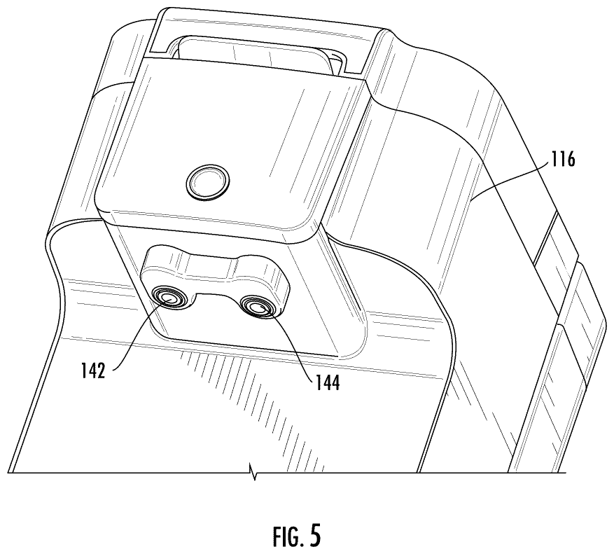

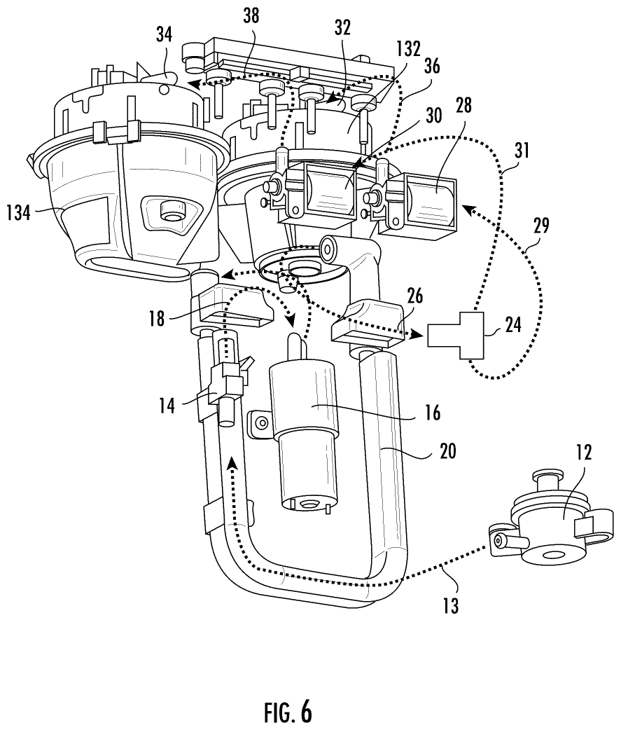

Referring now to FIG. 6, the components contained within the housing 102 are shown. The water reservoir 12 (represented by an exit valve in FIG. 6) is located at the rear of the housing 102 (see also FIG. 3). The line 13 leads from the water reservoir 12 to the flow meter 14, where the flow volume is monitored and signaled to the controller 40. The line 18 leads from the flow meter 14 to the cold water pump 16. The line 22 then leads from the cold water pump 16 to the hot water generator 20, which in the illustrated embodiment is a generally U-shaped flow-through heating unit. The line 26 is routed from the hot water generator 20 to the T-fitting 24, then the lines 29, 31 are routed to the valves 28, 30. The lines 36, 38 then lead from the valves 28, 30 to, respectively, the dispensing needles 32, 34.

In operation, if only a single serving of coffee is desired, the user fills the water reservoir 12 with water, fills one of the brew baskets 32, 34 with grounds (e.g., a pod, a grounds packet, or loose grounds), positions a receiving vessel (e.g., a mug) on the vessel receiving area 106, 108 corresponding to the filled brew basket 132, 134, and through the control panel 118 indicates which brew basket 132, 134 is to serve as the brewing chamber. The user then activates the brewing process, which proceeds with the appropriate one of the valves 28, 30 switched on (via the controller 40) to direct heated water to the selected brew basket 132, 134. The process ceases when the desired amount of beverage has been brewed into the vessel. The controller 40 maintains the appropriate valve 28, 30 in the open position and the other valve 30, 28 in the closed position.

If instead the user wishes to brew two servings at the same time, the user fills both brew baskets 132, 134 with grounds, positions vessels on both vessel receiving areas 106, 108, and indicates through the control panel 118 that two servings are to be brewed. Once the user activates the brewing process, brewing proceeds as described above, with the exception that after a predetermined time interval (e.g., 3 to 7 seconds), the controller 40 signals the valves 28, 30 to alternately open and close in order to direct heated water to the other brew basket 132, 134. (For example, if the brewing process began with the valve 28 positioned to direct heated water to the brew basket 132 and the valve 30 closed, after the predetermined time interval the controller signals the valve 28 to close and the valve 30 to open so that heated water is directed instead to the brew basket 134.) After a second predetermined time interval (typically the same as the first predetermined time interval), the controller 40 signals the valves 28, 30 to switch back to their original positions to direct heated water to the brew basket 132 again. This intermittent switching of the valves 28, 30 continues until brewing is completed.

Those of skill in this art will appreciate that the coffeemaker 10 may take different forms. For example, although the T-fitting 24 and the solenoid valves 28, 30 are illustrated and described herein, other arrangements may also be employed. For example, a single three-way valve may replace the T-fitting 24 and valves 28, 30. As used herein, the term “three-way valve assembly” is intended to encompass both of these arrangements as well as others in which an entering fluid is directed to flow from one of two exits while preventing flow into the other of the two exits.

As another alternative, brew baskets of different configurations may be employed. For example, the brew baskets 132, 134 may be replaceable by alternative brew baskets that are configured to best accommodate grounds of different forms. As shown in FIG. 7, the brew basket 132 is configured to receive grounds in a hard-shelled pod (which requires high pressure water for brewing). As shown in FIGS. 8A and 8B, the brew basket 134 (with its accompanying lid 136) is configured to receive grounds in a loose form (which require low pressure water for brewing). Either or both of the brew baskets 132, 134 can be switched out for the other type if needed. (Some coffeemaker embodiments are offered with two of each style of brew basket, with a compartment within the housing for storing the brew baskets not currently being used).

It will also be recognized that many of the other components of the coffeemaker (e.g., the heating unit, the flow meter, the pump) may be replaced with units that perform a similar function. Further, in some embodiments, some of these components may be combined (e.g., the pump and flow meter may be combined into a single unit). Also, these components may be arranged differently within the housing 102 (e.g., the flow meter 14 may be positioned after the pump 16).

Finally, those of skill in this art will appreciate that the coffeemaker 10 may be employed to brew other beverages, such as tea, hot chocolate, etc. As such, the terms “coffeemaker,” “beverage maker”, beverage-making machine,” and the like are intended to be interchangeable.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

1. A dual-vessel beverage-making machine, comprising:
a housing comprising:
a base with first and second vessel receiving areas;
a tower extending upwardly from the base; and
a dispensing arm that extends from the tower at least partially directly above the first and second vessel receiving areas;
a water reservoir mounted in the housing;
a first brew basket positioned in the dispensing arm and above the first vessel receiving area;
a second brew basket positioned in the dispensing arm and above the second vessel receiving area;
a heat generating unit fluidly connected with the water reservoir;
a pump fluidly connected with the water reservoir;
a three-way valve assembly fluidly connected with the heat generating unit, the first brew basket and the second brew basket, the three-way valve assembly configured to switch between a first position, in which fluid is permitted to flow to the first brew basket but not to the second brew basket, and a second position, in which fluid is permitted to flow to the second brew basket but not to the first brew basket; and
a controller operatively connected with the heat generating unit, the pump and the three-way valve assembly;
the controller being figured configured to switch the three-way valve assembly from the first position to the second position after a first predetermined time interval before completing brewing via the first brew basket.

2. The beverage-making machine defined in claim 1, wherein the first brew basket is configured to receive a hard-shelled beverage pod.

3. The beverage-making machine defined in claim 2, wherein the second brew basket is configured to receive a hard-shelled beverage pod.

4. The beverage-making machine defined in claim 1, wherein the controller is further configured to switch the three-way valve assembly from the second position to the first position after a second predetermined time interval before completing brewing via the second brew basket.

5. The beverage-making machine defined in claim 4, wherein the controller is configured to switch the three-way valve assembly between the first position and the second position every 3 to 7 seconds.

6. The beverage-making machine defined in claim 1, wherein a flow meter is fluidly connected between the water reservoir and the pump.

7. The beverage-making machine defined in claim 1, wherein the three-way valve assembly comprises first and second solenoid valves, and wherein the controller is operatively connected with each of the first and second solenoid valves.

8. The beverage-making machine defined in claim 1, further comprising at least one temperature sensor operatively connected with the hot water generator and the controller.

9. A method of brewing a beverage, comprising the steps of:
(a) providing a beverage-making machine as defined in claim 1;
(b) inserting first beverage grounds in the first brew basket;
(c) inserting second beverage grounds in the second brew basket;
(d) conveying water from the water reservoir to the first brew basket to brew a beverage with the first beverage grounds, wherein the three-way valve assembly is in the first position; then
(e) conveying water from the water reservoir to the second brew basket to brew a beverage with the second beverage grounds, wherein the three-way valve assembly is in the first position; and
(f) alternately repeating steps (c) and (d).

10. The method defined in claim 9, wherein step (d) is performed for between about 3 and 7 seconds.

11. The method defined in claim 10, wherein step (e) is performed for between about 3 and 7 seconds.

12. The method defined in claim 9, wherein the first beverage grounds differ from the second beverage grounds.

13. The method defined in claim 9, wherein the first beverage grounds is provided in a hard-shelled beverage pod.

14. The method defined in claim 13, wherein the second beverage grounds is provided in a hard-shelled beverage pod.

15. The method defined in claim 9, wherein the step (d) is performed at a different water pressure than step (e).

16. The method defined in claim 9, wherein step (e) is performed for the last time within 10 seconds of step (d) being performed for the last time.

17. The method defined in claim 9, wherein brewed liquid produced in step (d) is dispensed into a first vessel positioned on the first vessel receiving area, and brewed liquid produced in step (e) is dispensed into a second vessel positioned on the second vessel receiving area.

18. The method defined in claim 9, wherein brewed liquid produced in step (d) is dispensed into a vessel positioned on a third vessel receiving area that overlaps the first vessel receiving area and the second vessel receiving area, and wherein brewed liquid produced in step (e) is also dispensed into the vessel positioned on the third vessel receiving area.

19. The method defined in claim 18, wherein the first beverage grounds differ from the second beverage grounds.
